(19) United States
(12) Patent Application Publication
(10) Pub. No.: US 2026/0031558 A1
(43) Pub. Date: Jan. 29, 2026

(54) Terminal Module, Connector and Connector Assembly

(71) Applicant: Tyco Electronics (Shanghai) Co., Ltd., Shanghai (CN)

(72) Inventors: Chunming (Richard) Yu, Shanghai (CN); Xingjie (Steven) Ge, Shanghai (CN); Guangming (Suny) Zhao, Shanghai (CN); Yan (Bill) Lee, Shanghai (CN)

(73) Assignee: Tyco Electronics (Shanghai) Co., Ltd., Shanghai (CN)

(21) Appl. No.: 19/278,948

(22) Filed: Jul. 24, 2025

(30) Foreign Application Priority Data
Jul. 25, 2024 (CN) 202411010410.4

(51) Int. Cl. H01R 12/70; H01R 12/71; H01R 13/24; H01R 13/405; H01R 13/502; H01R 13/64

(52) U.S. Cl. CPC H01R 12/707; H01R 12/712; H01R 13/2407; H01R 13/405; H01R 13/502; H01R 13/64

(57) ABSTRACT

A terminal module comprises a row of terminals and an insulator. Each terminal of the row of terminals has an L-shaped fixing part and an elastic arm and a welding pin connected to respective ends of the L-shaped fixing part. The insulator is molded onto the L-shaped fixing parts of the row of terminals, such that the L-shaped fixing parts of the row of terminals are held in the insulator. The insulator is adapted to be installed and fixed into a connector housing.

### CROSS-REFERENCE TO RELATED APPLICATION

This application claims the benefit of Chinese Patent Application No. CN202411010410.4 filed on Jul. 25, 2024 in the State Intellectual Property Office of China, the whole disclosure of which is incorporated herein by reference.

### FIELD OF THE DISCLOSURE

The disclosure relates to a terminal module, a connector comprising the terminal module and a connector assembly comprising the connector.

### BACKGROUND OF THE INVENTION

In the prior art, a connector typically includes a housing, and terminals installed within the housing. The terminal has a welding pin exposed from the bottom of the housing and an elastic arm located inside the housing. The welding pins of the terminals are adapted to be soldered to a circuit board, and the elastic arms of the terminals are adapted to electrically contact mating terminals of a mating connector inserted into the housing. In the prior art, the structural strength of the terminal is weak, and the elastic arm of the terminal cannot guarantee stable forward contact force, resulting in unstable and reliable electrical contact between the terminal and the mating terminal.

### SUMMARY OF THE INVENTION

According to an embodiment of the present disclosure, a terminal module comprises a row of terminals and an insulator. Each terminal of the row of terminals has an L-shaped fixing part and an elastic arm and a welding pin connected to respective ends of the L-shaped fixing part. The insulator is molded onto the L-shaped fixing parts of the row of terminals, such that the L-shaped fixing parts of the row of terminals are held in the insulator. The insulator is adapted to be installed and fixed into a connector housing.

### DRAWINGS

The accompanying drawings incorporated therein and forming a part of the specification illustrate the present disclosure and, and together with the description, further serve to explain the principles of the disclosure and to enable those skilled in the relevant art to manufacture and use the embodiments described herein.

FIG. 1 shows an illustrative perspective view of a terminal module according to an exemplary embodiment of the present invention when viewed from the front side;

FIG. 2 shows an illustrative perspective view of a terminal module according to an exemplary embodiment of the present invention when viewed from the rear side;

FIG. 3 shows an illustrative exploded view of a terminal module according to an exemplary embodiment of the present invention when viewed from the rear side;

FIG. 4 shows an illustrative exploded view of a terminal module according to an exemplary embodiment of the present invention;

FIG. 5 shows an illustrative perspective view of a terminal module and an inner housing according to an exemplary embodiment of the present invention, wherein the terminal module has not yet been installed into the inner housing;

FIG. 6 shows a cross-sectional view of a terminal module and an inner housing according to an exemplary embodiment of the present invention, wherein the terminal module has not yet been installed into the inner housing;

FIG. 7 shows an illustrative perspective view of a terminal module and an inner housing according to an exemplary embodiment of the present invention;

FIG. 8 shows a cross-sectional view of a terminal module and an inner housing according to an exemplary embodiment of the present invention;

FIG. 9 shows an illustrative perspective view of a connector according to an exemplary embodiment of the present invention;

FIG. 10 shows a transverse sectional view of a connector according to an exemplary embodiment of the present invention; and

FIG. 11 shows a longitudinal sectional view of a connector according to an exemplary embodiment of the present invention, showing four terminal modules.

The features disclosed in this disclosure will become more apparent in the following detailed description in conjunction with the accompanying drawings, where similar reference numerals always identify the corresponding components. In the accompanying drawings, similar reference numerals typically represent identical, functionally similar, and/or structurally similar components. Unless otherwise stated, the drawings provided throughout the entire disclosure should not be construed as drawings drawn to scale.

### DETAILED DESCRIPTION

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to an embodiment of the present disclosure, a terminal module comprises: a row of terminals, each terminal comprising an L-shaped fixing part and an elastic arm and a welding pin connected to both ends of the L-shaped fixing part respectively; and an insulator which is injection molded onto the L-shaped fixing parts of the row of terminals, so that the L-shaped fixing parts of the row of terminals are held in the insulator. The insulator is suitable for being installed and fixed into a connector housing to ensure that the elastic arm of the terminal can make stable and reliable electrical contact with a mating terminal of a mating connector inserted into the connector housing.

According to another embodiment of the present disclosure, a connector comprises a connector housing, and the above terminal module installed and fixed into the connector housing. The welding pin of the terminal is exposed from the bottom of the connector housing for soldering to a circuit board, and the elastic arm of the terminal is used to make electrical contact with a mating terminal of a mating connector inserted into the connector housing.

According to another embodiment, a connector comprises: a connector housing; and four terminal modules which are installed in the connector housing and spaced apart in the longitudinal direction and the height direction of the connector housing. Each terminal module includes: a row of terminals, each terminal comprising an L-shaped fixing part and an elastic arm and a welding pin connected to both ends of the L-shaped fixing part respectively; and an insulator which is injection molded onto the L-shaped fixing parts of the row of terminals, so that the row of terminals and the insulator become an integral piece.

According to yet another embodiment of the present disclosure, a connector assembly. The connector assembly comprises the above connector, and a mating connector which is mated with the connector.

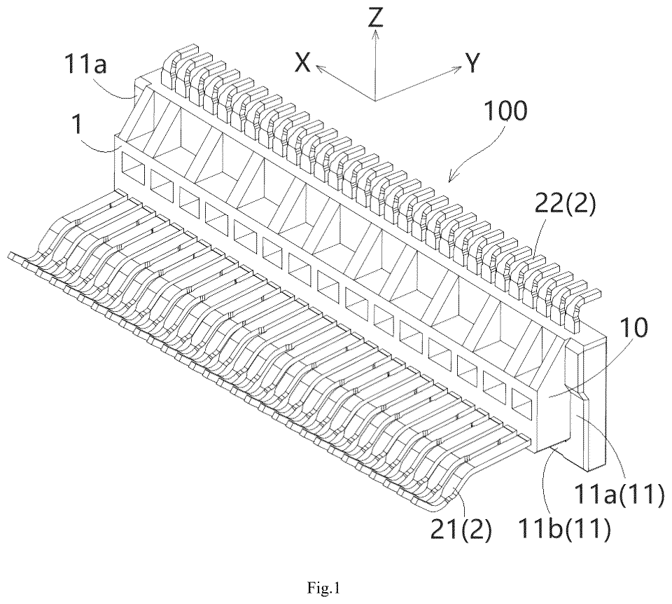

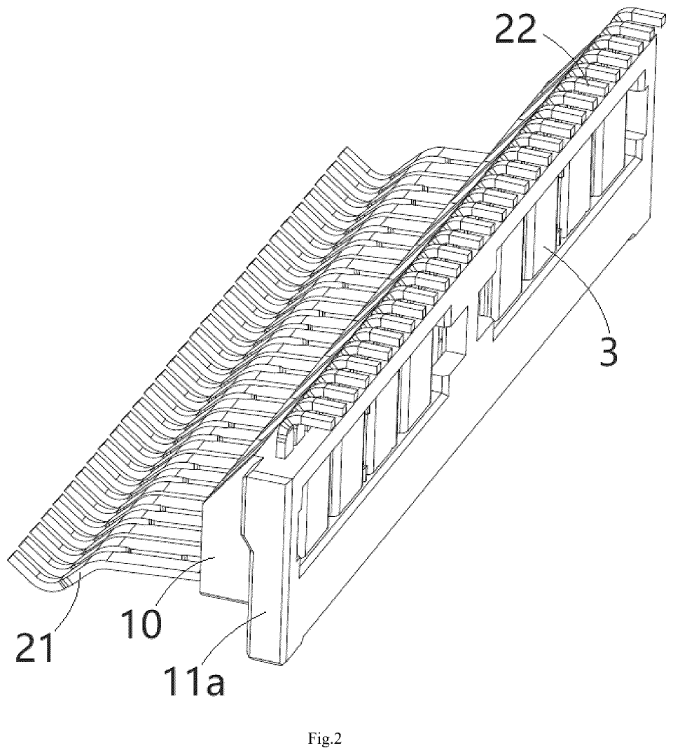

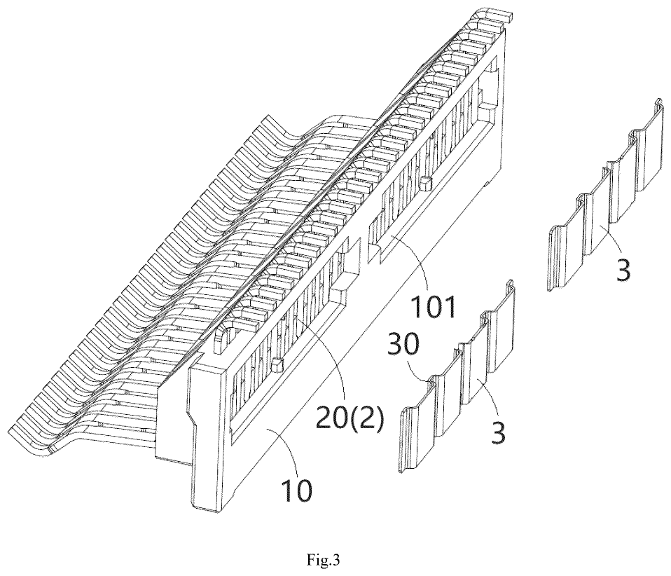

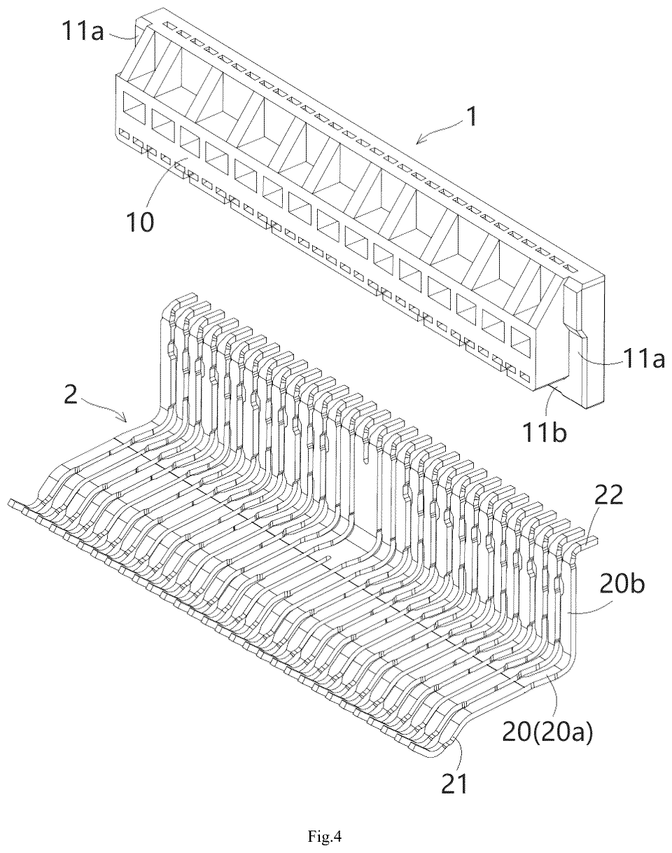

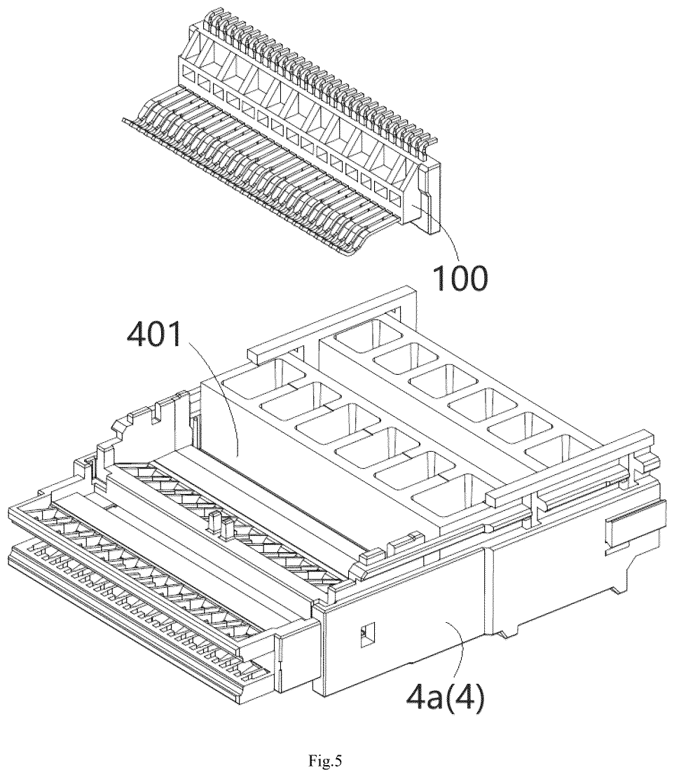

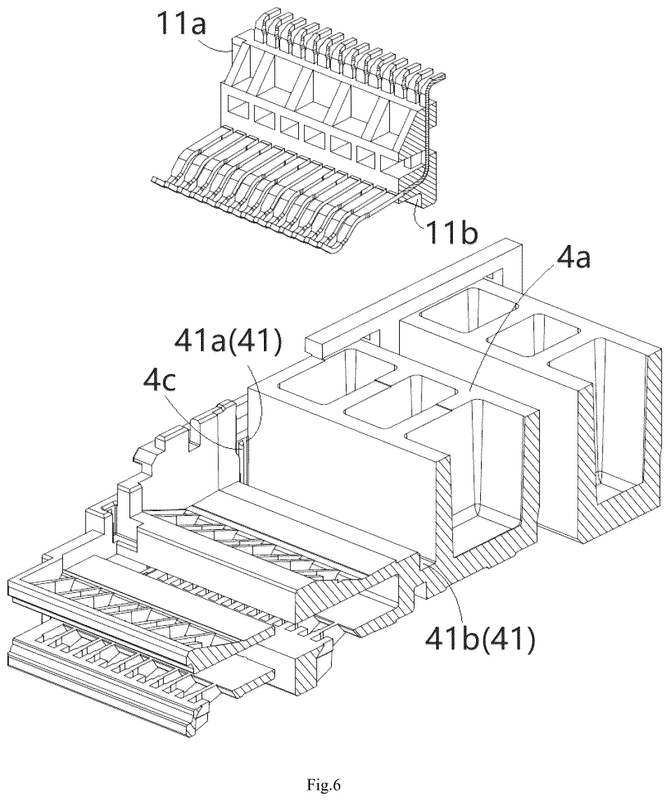

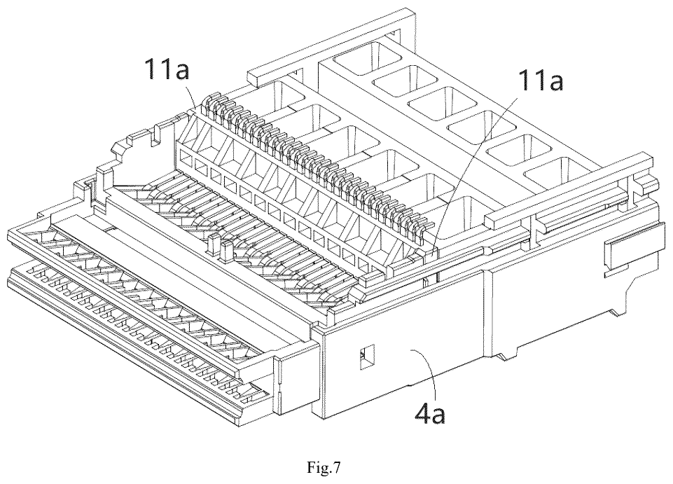

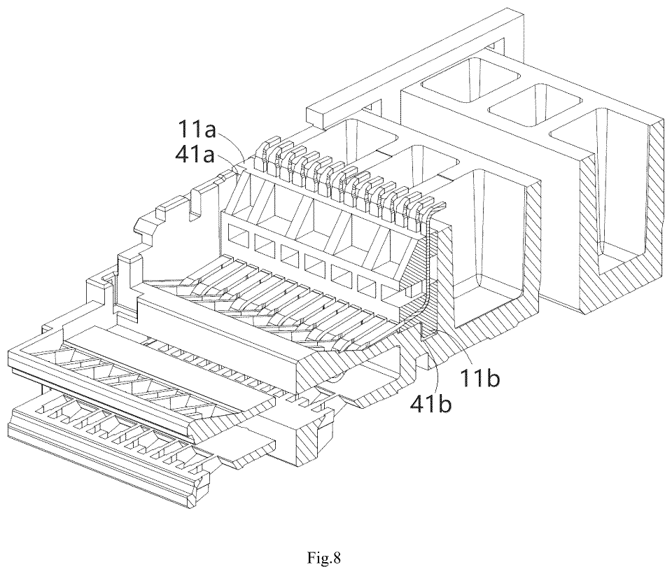

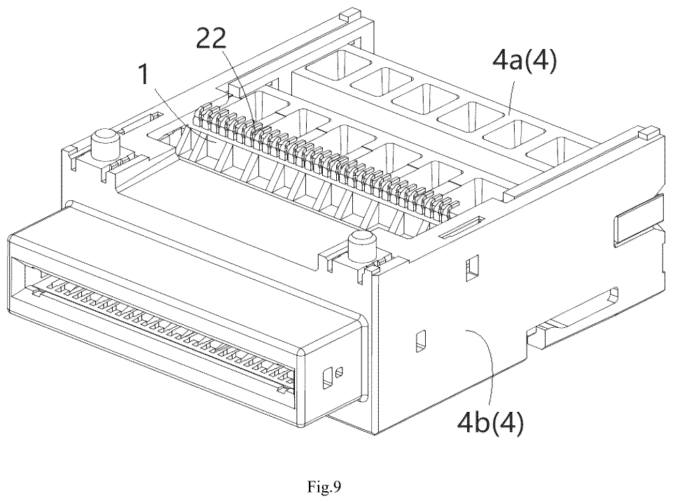

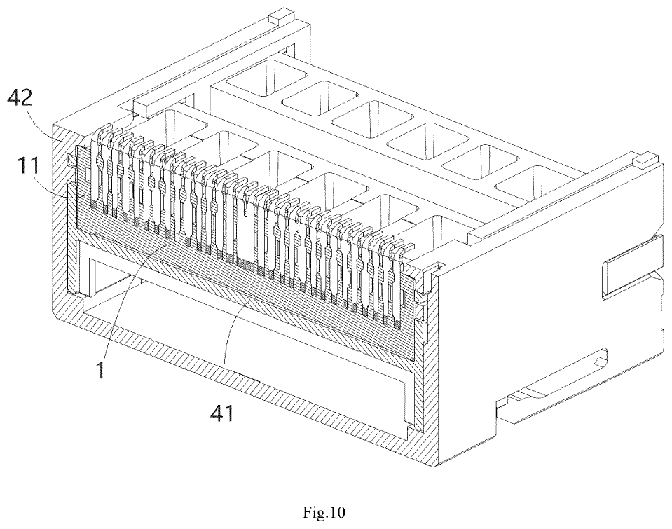

FIG. 1 shows an illustrative perspective view of a terminal module 100 according to an exemplary embodiment of the present invention when viewed from the front side. FIG. 2 shows an illustrative perspective view of the terminal module 100 according to an exemplary embodiment of the present invention when viewed from the rear side. FIG. 3 shows an illustrative exploded view of terminal module 100 according to an exemplary embodiment of the present invention when viewed from the rear side. FIG. 4 shows an illustrative exploded view of terminal module 100 according to an exemplary embodiment of the present invention. FIG. 5 shows an illustrative perspective view of the terminal module 100 and the inner housing 4a according to an exemplary embodiment of the present invention, wherein the terminal module 100 has not yet been installed into the inner housing 4a. FIG. 6 shows a cross-sectional view of terminal module 100 and inner housing 4a according to an exemplary embodiment of the present invention, wherein terminal module 100 has not yet been installed into inner housing 4a. FIG. 7 shows an illustrative perspective view of a terminal module 100 and an inner housing 4a according to an exemplary embodiment of the present invention. FIG. 8 shows a cross-sectional view of terminal module 100 and inner housing 4a according to an exemplary embodiment of the present invention. FIG. 9 shows an illustrative perspective view of a connector according to an exemplary embodiment of the present invention. FIG. 10 shows a transverse cross-sectional view of a connector according to an exemplary embodiment of the present invention.

As shown in FIGS. 1-10, in an exemplary embodiment of the present disclosure, a terminal module 100 is disclosed. The terminal module 100 includes a row of terminals 2 and an insulator 1. Each terminal 2 includes an L-shaped fixing part 20, as well as an elastic arm 21 and a welding pin 22 connected to both ends of the L-shaped fixing part 20, respectively. The insulator 1 is injection molded onto the L-shaped fixing parts 20 of a row of terminals 2 through an embedded injection molding process, so that the L-shaped fixing parts 20 of the row of terminals 2 are held in the insulator 1. The insulator 1 is suitable for installation and fixation into a connector housing 4 to ensure that the elastic arm 21 of terminal 2 can make stable and reliable electrical contact with a mating terminal of a mating connector inserted into the connector housing 4.

In the illustrated embodiment, the insulator 1 includes a main body 10 and a positioning rib 11. The main body 10 is used to hold the L-shaped fixing parts 20 of the row of terminals 2. The positioning rib 11 is formed on the side and/or top of the main body 10. The positioning rib 11 is suitable for being inserted and fixed into the positioning groove 41 of the connector housing 4, so that the insulator 1 cannot be moved relative to the connector housing 4 in the longitudinal direction Y and the transverse direction X.

The positioning rib 11 includes a pair of side positioning ribs 11a, which are located on two opposite sides of the main body 10 in the transverse direction X and extend along the height direction Z of the main body 10. The side positioning rib 11a is suitable for being inserted and fixed into a vertical positioning groove 41a of the connector housing 4.

The positioning rib 11 further includes a top positioning rib 11b, which is located on the top of the main body 10 and extends along the transverse direction X of the main body 10. The top positioning rib 11b is connected between the top of the pair of side positioning ribs 11a, and is suitable for being inserted and fixed into a horizontal positioning groove 41b of the connector housing 4. When the terminal module 100 is installed into the connector housing 4, the top and bottom surfaces of the side positioning ribs 11a are pressed against the inner wall surface of the connector housing 4, so that the insulator 1 cannot be moved relative to the connector housing 4 in the height direction Z.

The main body 10 of the insulator 1 is adapted to be installed into an installation slot 401 of the connector housing 4. The welding pins 22 of a row of terminals 2 extend from the top portion of the main body 10 of the insulator 1, and the elastic arms 21 of a row of terminals 2 extend from the front side of the bottom portion of the main body 10.

The L-shaped fixing part 20 of terminal 2 includes a horizontal extension portion 20a and a vertical extension portion 20b. The horizontal extension portion 20a extends along the longitudinal direction Y of the insulator 1. The vertical extension portion 20b is connected to the rear end of the horizontal extension portion 20a and extends along the height direction Z of the insulator 1. The elastic arm 21 of terminal 2 is connected to the front end of the horizontal extension portion 20a, and the welding pin 22 of terminal 2 is connected to the lower end of the vertical extension portion 20b, and the terminal 2 is an integral stamped part.

An opening 101 is formed on the rear side of the main body 10 of the insulator 1, so that a part of the vertical extension portion 20b of the L-shaped fixing part 20 of the terminal 2 is exposed through the opening 101. The terminal module 100 also includes a ground connection member 3, which is installed in the opening 101 on the rear side of the insulator 1, for electrically connecting multiple ground terminals in the row of terminals 2 together.

The ground connection member 3 includes multiple welding ribs 30, which extend along the height direction Z of the insulator 1 and are arranged in a row in the transverse direction X of the insulator 1. Multiple welding ribs 30 are respectively welded to the vertical extension portions 20b of the L-shaped fixing parts 20 of multiple ground terminals, so that the multiple ground terminals are electrically connected together by the ground connection member 3.

In another exemplary embodiment of the present invention, a connector is also disclosed. The connector includes a connector housing 4 and the aforementioned terminal module 100. The terminal module 100 is installed and fixed into the connector housing 4. The welding pin 22 of terminal 2 is exposed from the bottom of the connector housing 4 for soldering to a circuit board (not shown), and the elastic arm 21 of terminal 2 is used to make electrical contact with a mating terminal of a mating connector inserted into the connector housing 4.

The connector housing 4 includes an outer housing 4b and an inner housing 4a. The inner housing 4a is installed in the outer housing 4b. A positioning groove 41 is formed on the inner wall of the inner housing 4a, and the positioning rib 11 of the insulator 1 of the terminal module 100 is inserted and fixed into the positioning groove 41, so that the terminal module 100 cannot be moved relative to the connector housing 4 in the longitudinal direction Y and the transverse direction X. The top and bottom surfaces of the positioning ribs 11 of the insulator 1 of the terminal module 100 are respectively pressed against the inner wall surfaces of the inner housing 4a and the outer housing 4b, so that the terminal module 100 cannot be moved relative to the connector housing 4 in the height direction Z.

An installation slot 401 is formed in the inner housing 4a, and the main body 10 of the insulator 1 of the terminal module 100 is installed in the installation slot 401 of the inner housing 4a. The positioning groove 41 is formed on the inner side of the side wall and/or top wall of the inner housing 4a and is communicated with the installation slot 401. The positioning groove 41 includes a pair of vertical positioning grooves 41 formed on the inner side of a pair of side walls of the inner housing 4a. The pair of side positioning ribs 11a of the insulator 1 of the terminal module 100 are respectively inserted and fixed into the pair of vertical positioning grooves 41.

A raised rib 4c is formed on the inner wall surface of the vertical positioning groove 41a. The raised rib 4c extends along the height direction Z for interference fit with the side positioning rib 11a of the insulator 1.

The positioning groove 41 further includes a horizontal positioning groove 41b formed on the inner side of the top wall of the inner housing 4a. The top positioning rib 11b of the insulator 1 of the terminal module 100 is inserted and fixed into the horizontal positioning groove 41b.

The inner wall surface of the inner housing 4a is pressed against the top surface of a pair of side positioning ribs 11a of the insulator 1. The inner wall surface of the outer housing 4b is pressed against the bottom surface of a pair of side positioning ribs 11a of the insulator 1, so that the insulator 1 cannot be moved relative to the connector housing 4 in the height direction Z.

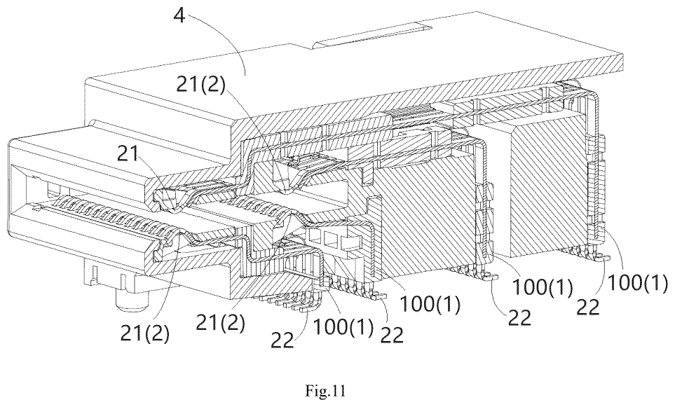

FIG. 11 shows a longitudinal sectional view of a connector according to an exemplary embodiment of the present invention, wherein four terminal modules 100 are shown. As shown in FIGS. 1-11, in another exemplary embodiment of the present invention, a connector is also disclosed. The connector includes a connector housing 4 and four terminal modules 100. Four terminal modules 100 are installed in the connector housing 4 and spaced apart in the longitudinal direction Y and height direction Z of the connector housing 4. Each terminal module 100 includes a row of terminals 2 and an insulator 1. Each terminal 2 includes an L-shaped fixing part 20, as well as an elastic arm 21 and a welding pin 22 connected to both ends of the L-shaped fixing part 20, respectively. The insulator 1 is injection molded onto the L-shaped fixing part 20 of a row of terminals 2, making the row of terminals 2 and insulator 1 an integral piece. One of the four terminal modules 100 is the terminal module 100 shown in FIGS. 1 to 10, while the other three terminal modules 100 have a similar structure but different dimensions to the terminal module 100 shown in FIGS. 1 to 10.

In the illustrated embodiment, the welding pins 22 of a row of terminals 2 of each terminal module 100 are exposed from the bottom of the connector housing 4 and arranged in a row along the transverse direction of the connector housing 4. The welding pins 22 of adjacent terminal modules 100 are spaced apart in the longitudinal direction of the connector housing 4.

The four terminal modules 100 are sequentially referred to as the first terminal module 100, the second terminal module 100, the third terminal module 100, and the fourth terminal module 100 from front to back. The elastic arm 21 of the first terminal module 100 and the elastic arm 21 of the fourth terminal module 100 are spaced opposite each other in the height direction of the connector housing 4. The elastic arm 21 of the second terminal module 100 and the elastic arm 21 of the third terminal module 100 are spaced opposite each other in the height direction of the connector housing 4. The elastic arms 21 of the first terminal module 100 and the fourth terminal module 100 are located in front of the elastic arms 21 of the second terminal module 100 and the third terminal module 100.

The second terminal module 100 is the terminal module 100 shown in FIGS. 1 to 10. The first terminal module 100, the third terminal module 100, and the fourth terminal module 100 have similar structures to the terminal module 100 shown in FIGS. 1 to 10, but with different sizes. As shown in FIGS. 1-11, in another exemplary embodiment of the present invention, a connector assembly is also disclosed. The connector assembly includes a connector and a mating connector. The matching connector is mated with the connector.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A terminal module, comprising:
a row of terminals, each terminal having an L-shaped fixing part and an elastic arm and a welding pin connected to respective ends of the L-shaped fixing part; and
an insulator molded onto the L-shaped fixing parts of the row of terminals, such that the L-shaped fixing parts of the row of terminals are held in the insulator, the insulator is adapted to be installed and fixed into a connector housing.

2. The terminal module according to claim 1, wherein the insulator comprises:
a main body retaining the L-shaped fixing parts of the row of terminals; and
a positioning rib formed on a side and/or a top of the main body, the positioning rib is adapted to be inserted and fixed into a positioning groove of the connector housing, such that insulator cannot be moved relative to the connector housing in a longitudinal direction and a transverse direction.

3. The terminal module according to claim 2, wherein the positioning rib includes a pair of side positioning ribs respectively located on two opposite sides in the transverse direction of the main body and extending along the height direction of the main body, the side positioning rib is adapted to be inserted and fixed into a vertical positioning groove of the connector housing.

4. The terminal module according to claim 3, wherein the positioning rib further includes a top positioning rib arranged on the top of the main body and extending along the transverse direction of the main body, the top positioning rib is connected between the top of the pair of side positioning ribs, and is adapted to be inserted and fixed into a horizontal positioning groove of the connector housing.

5. The terminal module according to claim 4, wherein when the terminal module is installed into the connector housing, the top and bottom surfaces of the side positioning ribs are respectively pressed against the inner wall surface of the connector housing, such that the insulator cannot be moved relative to the connector housing in the height direction.

6. The terminal module according to claim 2, wherein the main body of the insulator is adapted to be installed into an installation slot of the connector housing, and the welding pins of the row of terminals extend from the top portion of the main body of the insulator, and the elastic arms of the row of terminals extend from the front side of the bottom portion of the main body.

7. The terminal module according to claim 6, wherein the L-shaped fixing part of the terminal includes:
a horizontal extension portion extending along a longitudinal direction of the insulator; and
a vertical extension portion connected to the rear end of the horizontal extension portion and extending along the height direction of the insulator, the elastic arm of the terminal is connected to the front end of the horizontal extension portion, the welding pin of the terminal is connected to the lower end of the vertical extension portion, and the terminal is an integral stamped part.

8. The terminal module according to claim 7, wherein:
an opening is formed on the rear side of the main body of the insulator, allowing a portion of the vertical extension portion of the L-shaped fixing part of the terminal to be exposed through the opening; and
the terminal module further includes a ground connection member installed in the opening on the rear side of the insulator for electrically connecting multiple ground terminals in the row of terminals together.

9. The terminal module according to claim 8, wherein:
the ground connection member includes multiple welding ribs extending along the height direction of the insulator and arranged in a row in the transverse direction of the insulator; and
the multiple welding ribs are respectively welded to the vertical extension portions of the L-shaped fixing parts of the multiple ground terminals, such that the multiple ground terminals are electrically connected together by the ground connection member.

10. A connector, comprising:
a connector housing; and
a terminal module installed and fixed into the connector housing, including:
a row of terminals, each terminal having an L-shaped fixing part and an elastic arm and a welding pin connected to respective ends of the L-shaped fixing part; and
an insulator molded onto the L-shaped fixing parts of the row of terminals, such that the L-shaped fixing parts of the row of terminals are held in the insulator, the insulator is adapted to be installed and fixed into a connector housing, the welding pin of the terminal is exposed from the bottom of the connector housing for soldering to a circuit board, and the elastic arm of the terminal is used to make electrical contact with a mating terminal of a mating connector inserted into the connector housing.

11. The connector according to claim 10, wherein the connector housing comprises:
an outer housing; and
an inner housing installed in the outer housing, a positioning groove is formed on the inner wall of the inner housing, and the positioning rib of the insulator of the terminal module is inserted and fixed into the positioning groove, such that the terminal module cannot be moved relative to the connector housing in the longitudinal direction and the transverse direction.

12. The connector according to claim 11, wherein the top and bottom surfaces of the positioning ribs of the insulator of the terminal module are respectively pressed against the inner wall surfaces of the inner housing and the outer housing, such that the terminal module cannot be moved in the height direction relative to the connector housing.

13. The connector according to claim 12, wherein:
an installation slot is formed in the inner housing, and the main body of the insulator of the terminal module is installed in the installation slot of the inner housing; and
the positioning groove is formed on the inner side of the side wall and/or top wall of the inner housing and is communicated with the installation slot.

14. The connector according to claim 13, wherein the positioning groove includes a pair of vertical positioning grooves respectively formed on the inner side of a pair of side walls of the inner housing, and a pair of side positioning ribs of the insulator of the terminal module are respectively inserted and fixed into the pair of vertical positioning grooves.

15. The connector according to claim 14, wherein a raised rib is formed on the inner wall surface of the vertical positioning groove, which extends along the height direction and is used for interference fit with the side positioning rib of the insulator.

16. The connector according to claim 14, wherein the positioning groove further comprises a horizontal positioning groove formed on the inner side of the top wall of the inner housing, and the top positioning rib of the insulator of the terminal module is inserted and fixed into the horizontal positioning groove.

17. The connector according to claim 16, wherein the inner wall surface of the inner housing is pressed against the top surface of the pair of side positioning ribs of the insulator, and the inner wall surface of the outer housing is pressed against the bottom surface of the pair of side positioning ribs of the insulator, so that the insulator cannot be moved relative to the connector housing in the height direction.

18. A connector, comprising:
a connector housing; and
four terminal modules installed in the connector housing and spaced apart in the longitudinal direction and the height direction of the connector housing, wherein each terminal module includes:
a row of terminals, each terminal comprising an L-shaped fixing part and an elastic arm and a welding pin connected to both ends of the L-shaped fixing part respectively; and
an insulator injection molded onto the L-shaped fixing parts of the row of terminals, such that the row of terminals and the insulator become an integral piece, one of the four terminal modules is the terminal module according to claim 1.

19. The connector according to claim 18, wherein the welding pins of the row of terminals of each terminal module are exposed from the bottom of the connector housing and arranged in a row along the transverse direction of the connector housing, and the welding pins of adjacent terminal modules are spaced apart in the longitudinal direction of the connector housing.

20. The connector according to claim 18, wherein:
the four terminal modules are sequentially referred to as the first terminal module, the second terminal module, the third terminal module, and the fourth terminal module from front to back;
the elastic arm of the first terminal module and the elastic arm of the fourth terminal module are spaced opposite each other in the height direction of the connector housing;
the elastic arm of the second terminal module and the elastic arm of the third terminal module are spaced opposite each other in the height direction of the connector housing; and
the elastic arms of the first terminal module and the fourth terminal module are located in front of the elastic arms of the second terminal module and the third terminal module.
